(19) United States
(12) Patent Application Publication
(10) Pub. No.: US 2009/0314851 A1
(43) Pub. Date: Dec. 24, 2009

(54) Dual hose showerhead

(76) Inventor: Michael Bonacci, New York, NY (US)

Correspondence Address: FURGANG & ADWAR, 2 CROSFIELD AVENUE, WEST NYACK, NY, 10994, US

(21) Appl. No.: 11/471,371

(22) Filed: Jun. 20, 2006

Related U.S. Application Data
(63) Continuation-in-part of application No. 11/373,364, filed on Mar. 10, 2006, now abandoned.

(51) Int. Cl. B05B 7/26

(52) U.S. Cl. 239/10; 239/310

(57) ABSTRACT

An apparatus and method for dispensing at least one fluid. A receiving section includes a first conduit and a second conduit. A dispensing section includes a faceplate, including a first plurality of recesses and a second plurality of recesses. A diameter of each recess of the first plurality of recesses is smaller than a diameter of each recess of the second plurality of recesses. The first conduit is connected to provide a flow of water for dispensing through the first plurality of recesses and the second conduit is connected to provide one of a water or soap and water solution for dispensing through the second plurality of recesses.

### FIELD OF THE INVENTION

The present invention relates to showerheads and, more specifically, to showerheads able to expel water and at least one substance.

### BACKGROUND OF THE INVENTION

Presently the general concept of supplying soapy water and clean water through separate conduits to a common dispensing device or head, each conduit having a separate orifice or holes exists in the prior art.

One patent disclosing a dual hose dispenser is U.S. Pat. No. 4,461,052 issued to Mostul which discloses a scrubbing brush having two conduits. The first conduit provides clear water and a second conduit provides soapy water. The second conduit terminates in an orifice, while the first conduit terminates in the nozzle. However, a noted drawback with the Mostul dispenser is the uniform arrangement of dispensing holes in the scrubbing brush.

Another US patent disclosing a dual hose dispenser is U.S. Pat. No. 6,786,431 issued to Song. Song discloses a washing device for automobiles having a pressure head equipped with a soap water tank and a water pipe with a water nozzle. A switch on the handle controls the soap water and the fresh water openings. Similarly to Mostul, the Song dual hose dispenser also provides a uniform arrangement of dispensing holes, wherein the holes through which the water flows are the same as the holes through which the soap water flows.

U.S. Pat. No. 4,113,182 issued to Brago discloses a spray gun cleaning system having individual fluid sources connected to a mixing chamber by individual conduits. The output of the mixing chamber is connected to a spray nozzle. This apparatus includes a single set of holes from which the fluids flow. Thus, the single set of holes are not specific to a particular conduit.

While these devices may be suitable for the purposes for which they were designed, they would not be suitable for the purposes of the present invention, as hereinafter described.

### SUMMARY OF THE INVENTION

An apparatus dispenses at least one fluid. A receiving section includes a first conduit and a second conduit. A dispensing section includes a faceplate, including a first plurality of recesses and a second plurality of recesses. A diameter of each recess of the first plurality of recesses is smaller than a diameter of each recess of the second plurality of recesses. The first conduit is connected to provide a flow of water for dispensing through the first plurality of recesses and the second conduit is connected to provide one of a water or soap and water solution for dispensing through the second plurality of recesses.

A method for dispensing at least one fluid. A receptacle is connected to a source of water for receiving water in first and second compartments thereof. A soap solution is poured into the second compartment. A first valve is selectively pivoted between a first position allowing water to flow from the first compartment for dispensing through a first and second plurality of apertures in a showerhead. A first valve is selectively pivoted between a second position allowing a soap solution to flow from the second compartment for dispensing through the second plurality of apertures in the showerhead. A first valve is selectively pivoted between a third position allowing water to flow from the first compartment for dispensing through the first plurality of apertures in the showerhead, and the soap solution flows from the second compartment for dispensing through the second plurality of apertures in the showerhead.

It is an object to provide a dual hose showerhead.

Another object is to provide a dual hose showerhead having a first hose for transporting water and a second hose for transporting a soap and water solution.

It is another object to provide a dual hose showerhead that includes a single compartmentalized container wherein water is retained in a first compartment and soap to form the soap and water solution is retained in a second compartment.

Yet another object is to provide a dual hose showerhead wherein a first plurality of apertures having different sized openings from a second plurality of apertures in a faceplate of the showerhead.

Still yet another object is to provide a dual hose showerhead having two sets of a plurality of apertures, one set larger than the other and wherein the soap and water solution flows through larger openings of the first and second plurality of apertures.

It is another object to provide a dual hose showerhead wherein a user selects one of water, a soap and water solution or both water and a soap and water solution to be dispensed through the first and second plurality of apertures.

Additionally, it is another object to provide a dual hose showerhead that entirely expels the soap residue therefrom and thereby prevents blockage of the plurality of apertures.

### BRIEF DESCRIPTION OF THE DRAWING FIGURES

In order that the invention may be more fully understood, it will now be described, by way of example, with reference to the accompanying drawing in which:

FIG. 1 is a view of the face of the showerhead nozzle of the dual hose showerhead system;

FIG. 2 is a side view of the showerhead of the dual hose showerhead system;

FIG. 3 is a side cross-sectional view of the dual conduit hose and nozzle of the showerhead system;

FIG. 4 is a cross sectional view of the valve controlling the flow of water into the showerhead of the showerhead system;

FIG. 5 is a cross sectional view of the dual hose showerhead system;

FIG. 6 is a cross sectional view of an alternate embodiment of the dual hose showerhead system;

FIG. 7 is a flow diagram detailing the operation of the dual hose showerhead system;

FIG. 8 is a flow diagram detailing the operation of the dual hose showerhead system for producing a mix flow of both clean and soapy water;

FIG. 9 is a flow diagram detailing the operation of the dual hose showerhead system for providing a flow of soapy water; and

FIG. 10 is a flow diagram detailing the shut down operation of the dual hose showerhead system.

### DETAILED DESCRIPTION OF THE INVENTION

The following discussion describes the present invention. This discussion should not be construed, however, as limiting the invention to that particular embodiment. Practitioners skilled in the art will recognize numerous other embodiments as well.

Turning now descriptively to the drawings, in which similar reference characters denote similar elements throughout the several views, FIGS. 1 through 10 illustrate a dual hose showerhead system which is indicated generally by the reference numeral 10 and which will be referred to hereinafter as “system 10”.

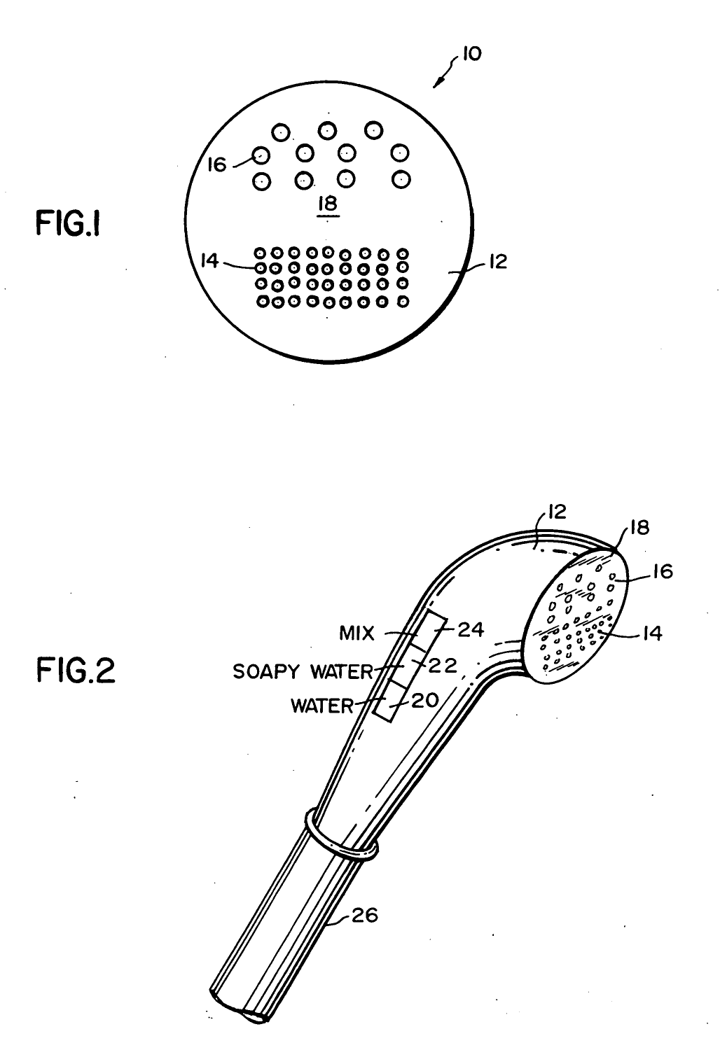

FIG. 1 is a view of the face of the showerhead nozzle of the dual hose showerhead system 10. Shown herein is a faceplate 18 of the showerhead 12. The faceplate 18 may include a plurality of first apertures 14 and a plurality of second apertures 16. Herein, the second apertures 16 may each have larger openings and may be fewer in number than the first apertures 14. The pattern, shape, and number of individual apertures of each of the plurality of first apertures 14 and the plurality, pattern, shape and number of the individual second apertures 16 are shown for purposes of example. While any number, shape, and pattern of apertures may be used, in the example provided herein, the first apertures 14 may be in the shape, size, and configuration of a typical showerhead and the second apertures are relative to the first apertures 14 significantly larger, six in number. Each of the larger apertures 16 may have a helical configuration with the wider or larger end of each aperture 16 defining an exit port from the faceplate 18. Clean water may be able to flow through both the first apertures 14 and the second apertures 16 at selected times, as will be described hereinafter with specific reference to FIG. 2. Additionally, a solution of soap and clean water, hereinafter “soapy water” may only flow through the second apertures 16. The larger openings of the second apertures 16 with respect to the first apertures 14 allows soap residue to be expelled entirely therefrom and thereby prevent blockage of the second apertures 16. The manner by which water and soapy water are expelled from the faceplate 18 of the nozzle will be discussed hereinafter with specific reference to FIGS. 2-8. The aperture openings may take any shape such as, for example, circular, in which instance the larger openings 16 may have a larger diameter than the second set of apertures 16.

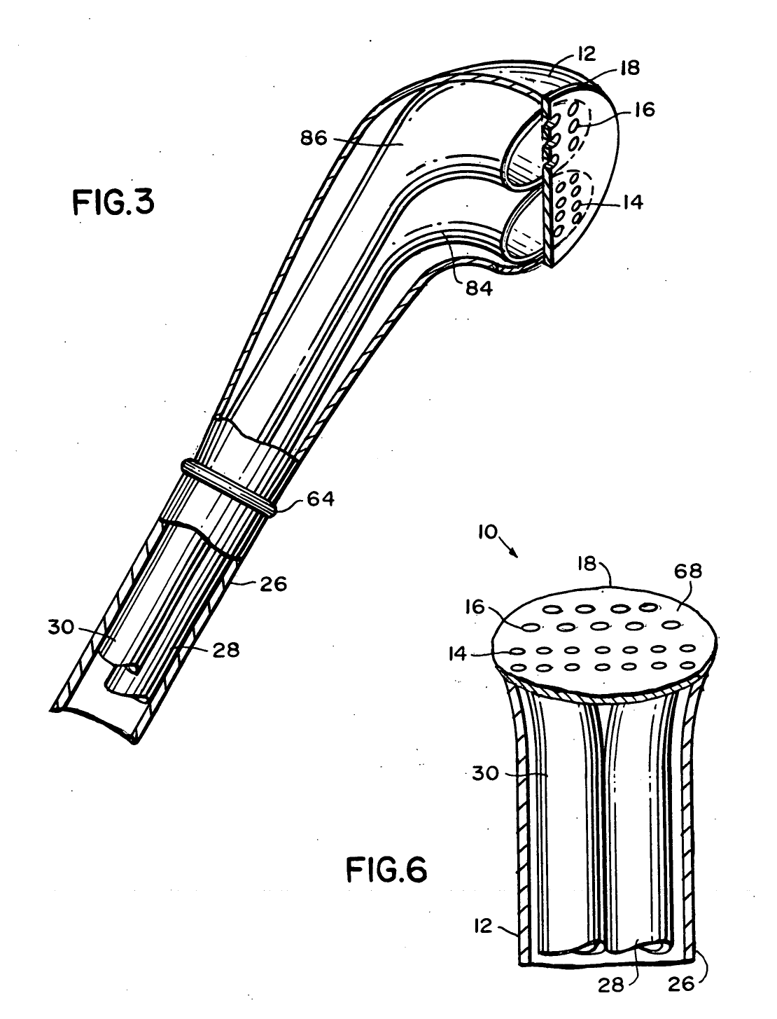

FIG. 2 is a side view of the dual hose showerhead system 10. The dual hose showerhead system 10 may include the showerhead 12 attached to a hose sheath 26. A first conduit 28 and a second conduit 30 may be positioned within the hose sheath 26 and extend substantially parallel thereto, shown in FIG. 3. The hose sheath 26 may prevent the conduits 28, 30 from getting tangled with one another. Clean water may flow through the first conduit 28 and soapy water may flow through the second conduit 30 as will be described hereinafter with specific reference to FIG. 4.

The faceplate 18 of the showerhead may, as indicated, include the plurality of first apertures 14 and the plurality of second apertures 16. Also as described above, each of the second apertures 16 may have larger openings and may be fewer in number and helically shaped than the first apertures 14. Clean water may be able to flow through both the first apertures 14 and the second apertures 16 at selected times, as will be described below. Additionally, soapy water may only flow through the second apertures 16. The relatively larger openings of the second apertures 16 allow the soapy water and the soapy residue to be expelled entirely therefrom and for preventing blockages of the apertures 16.

A user may selectively determine which substance will flow through the first and second apertures 14, 16 by depressing one of a plurality of buttons 20, 22, 24. Herein the buttons 20, 22, 24 may be located on the showerhead 12. However, this is for purposes of example only and the buttons 20, 22, 24 may be located in any location that is easily accessible to the user. Depression of the first button 20 may cause clean water to flow through both the first and second apertures 14, 16. Alternatively, clean water flowing through both the first and second apertures 14, 16 may be the default operation of the dual hose showerhead system 10. During default operation, when the shower is turned on, clean water may flow through both the first and second apertures 14, 16 regardless of whether the first button 20 is depressed. Depression of the second button 22 may cause soapy water to flow through the second apertures 16 only. Depression of the third button 24 may cause clean water to flow through the first apertures 14 and soapy water to flow through the second apertures 16 simultaneously.

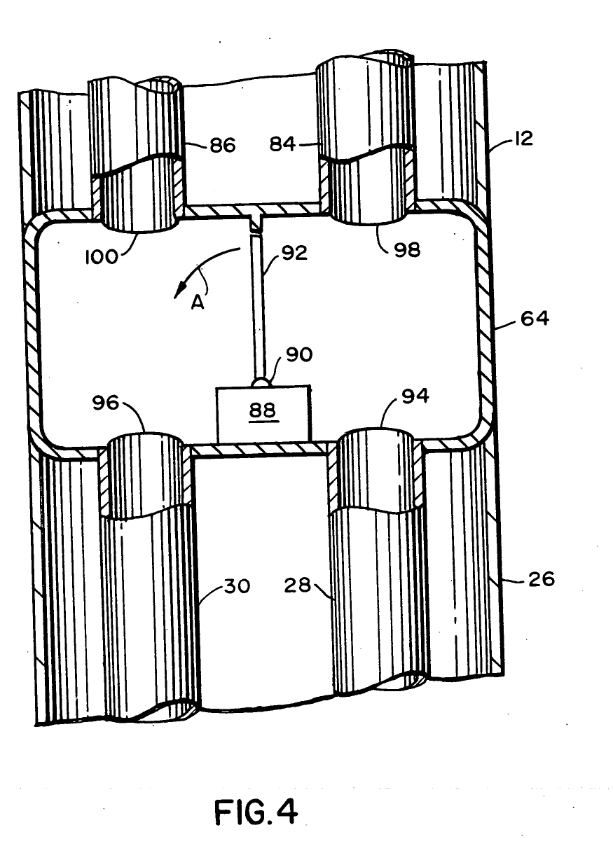

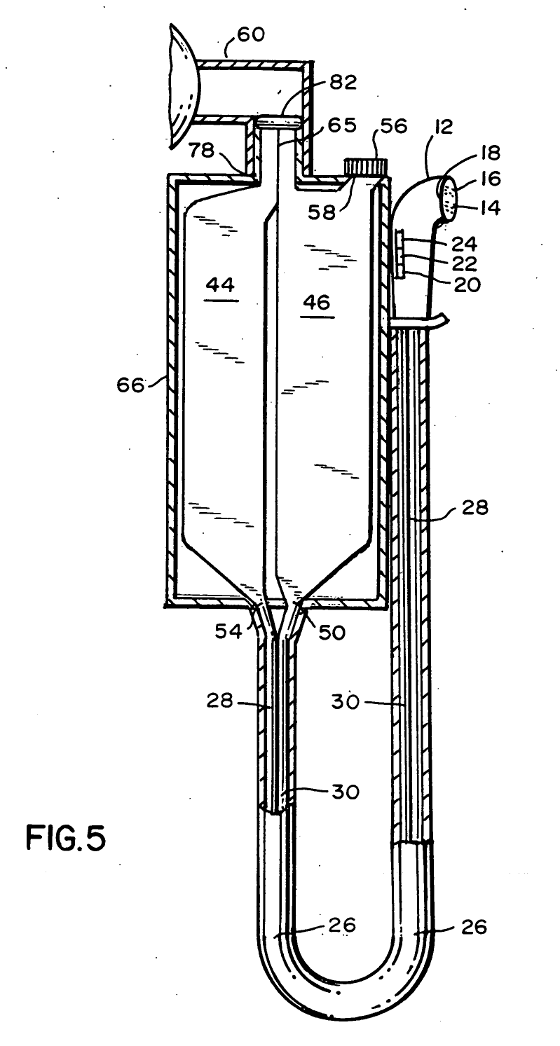

FIG. 3 is a cross sectional view of the dual hose showerhead system 10. The dual hose showerhead system 10 may include the showerhead 12 attached to the hose sheath 26. The first conduit 28 may extend within the sheath 26. The first conduit 28 may be connected to a first channel 84, within the showerhead 12, via a first valve 64, as will be described in more detail with respect to FIG. 4. The first channel 84 may be connected to the plurality of first apertures 14. Additionally the second conduit 30 may also extend within the sheath 26. The second conduit 30 may connect to a second channel 86, within the showerhead 12, via the first valve 64. The second channel 86 may be connected to the plurality of second apertures 16. The hose sheath 26 may prevent the first and second conduits 28, 30 from getting tangled with one another. Clean water may flow through the first conduit 28 and soapy water may flow through the second conduit 30 as will be described hereinafter with specific reference to FIG. 5.

As can be seen from this figure, the faceplate 18 may include the plurality of first apertures 14 and the plurality of second apertures 16. Each of the second apertures 16 may, as previously discussed, have larger openings relative to the first apertures 14 and may be fewer in number than the first apertures 14. Clean water may be able to flow through both the first apertures 14 and the second apertures 16 at selected times, as described below. Soapy water may only flow through the second apertures 16. The larger openings of the second apertures 16 may allow the soap residue from the soapy water to be expelled entirely therefrom and thereby prevent blockage of the apertures 16.

FIG. 4 is a cross sectional view of the first valve 64 that may govern the flow of water from the first and second conduits 28, 30 into the showerhead of the dual hose showerhead system 10. The conduit 30 for carrying soap-water may have a smaller diameter than the conduit 28 for carrying water. In this way, the soap-water combination in conduit 30 may be under relatively greater pressure than the water in the other conduit 28. The first valve 64 may connect the hose sheath 26 to the showerhead 12. The hose sheath 26 may house both the first conduit 28 and the second conduit 30 and may prevent them from getting tangled with one another. The first conduit 28 may be connected to the first valve 64 at a first input port 94 and the second conduit 30 may be connected to the first valve 64 at a second input port 96. The first valve 64 may house a control box 88 positioned between the first conduit 28 and second conduit 30 having a hinge 90 with a moveable partition 92 attached thereto. The first channel 84 may be connected to the first valve 64 at a first output port 98 and the second channel 86 may be connected to the first valve 64 at a second output port 100. The first input port 94 may be located on a side of the first valve 64 opposite from and aligned with the first output port 98 and the second input port 96 may be located on a side of the valve opposite from and aligned with the second output port 100. The control box 88 may control the position of the moveable partition 92 in response to depression of one of the plurality of buttons 20, 22, 24.

The user may selectively determine the substance flowing through the first and second apertures 14, 16 by depressing one of the plurality of buttons 20, 22, 24 located on the showerhead 12 as discussed hereinbefore. The buttons 20, 22, 24 may be located on the outer surface of the showerhead 12 as shown in FIG. 2. The arrangement of the buttons 20, 22, 24 and the configuration of the buttons 20, 22, 24 may be one of choice. In the example provided here, the soap button 22 is diamond shaped and disposed, relative to the other buttons 22, 24, closer to the faceplate 18. The water and mix buttons 20, 24, respectively, are rectangular in shape and located rearwardly of the faceplate 18 and the soap button 22. The shape of the soap button 22 and the relative location of the water and mix buttons 20, 24 may assist the user is distinguishing one button from the other while in use.

Depression of the water button 20 may cause clean water to flow through the first conduit 28 and into the first valve 64 via the first input port 94. The moveable partition 92 may move on the hinge 90 as indicated by directional arrow A to cover the second conduit 30 thereby allowing the clean water to flow from the first conduit through both the first channel 84 and the second channel 86 via both the first output port 98 and the second output port 100. The clean water may flow from the first channel 84 and the second channel 86 through each of the plurality of first apertures 14 and second apertures 16 respectively. Alternatively, the clean water flowing through both the first and second apertures 14, 16 may be the default operation of the dual hose showerhead system 10. During default operation, regardless of whether the first button 20 is depressed, when the shower is turned on, the moveable partition 92 may cover the second conduit 30 and the clean water may flow through the first and second channels 84, 86, via both the first and second output ports 98, 100, and may exit the first and second apertures 14, 16 respectively.

Depression of the second or soap button 22 may cause soapy water to flow through the second conduit 30 and into the first valve 64 via the second input port 96. The moveable partition 92 may be positioned vertically thereby dividing the first valve 64 and permitting the soapy water to flow solely into the second channel 86 via the second output port 100. The soapy water may flow from the second channel 86 through the plurality of second apertures 16 with a turning stream caused by the helixes.

Depression of the third or mix button 24 may allow clean water to flow through the first conduit 28 and into the first valve 64, via the first input port 94, while simultaneously allowing soapy water to flow through the second conduit 30 and into the first valve 64 via the second input port 96. The moveable partition 92 may be positioned within the first valve 64 so as to divide the first valve 64 and to permit the clean water to flow solely into the first channel 84 via the first output port 98 and the soapy water to flow solely into the second channel 86 via the second output port 100. The clean water may flow from the first channel 84 through the plurality of first apertures 14 while the soapy water may flow from the second channel 86 through the plurality of second apertures 16.

FIG. 5 is a cross sectional view of the dual hose showerhead system 10. A water pipe 60 may extend from the shower wall and may be connected to a container 66 at an input port 78 thereof. A second valve 82 may extend from the input port 78 into the pipe 60 for governing the entrance of water from the pipe 60 through the input port 78 and into the container 66. The pipe 60 may have an L-shape, as is well known in the art, with one leg 61 extending horizontally out of the wall (not shown) and a downward leg 63. The second valve 82 may include a divider 65 for dividing the flow of water through the input port 78.

The container 66, which may be further secured to the shower wall for support, may include a first compartment 44 and a second compartment 46. The first compartment 44 may be connected to a first side of the second valve 82 allowing water to flow therein. The first compartment 44 may have an egress port 54 connected to the first conduit 28. In the embodiment shown herein, the first compartment 44 may retain only clean water from the water pipe 60. The second compartment 46 may be connected to a second side of the second valve 82 allowing water to flow therein. The second compartment 46 may have an egress port 50 which may be connected to the second conduit 30. The container 66 may also include an ingress port 56 for providing access to the second compartment 46. The ingress port 56 may be selectively covered by a cap 58. The ingress port 56 may permit a user to add soap to the second compartment 46. The soap can be at least one of liquid or powdered.

The first conduit 28 and second conduit 30 may be connected to the showerhead 12 at ends opposite connection to the container 66 via the first valve 64, as described hereinabove with specific reference to FIG. 4. The faceplate 18 of the showerhead 12 may include the plurality of first apertures 14 and the plurality of second apertures 16. Herein, each of the second apertures 16 may have larger openings and may also be fewer in number than the first apertures 14. Clean water may be able to flow through both the first apertures 14 and the second apertures 16 at selected times. Soapy water may only flow through the second apertures 16. The larger openings of the second apertures 16 may allow the soap residue from the soapy water to be expelled entirely therefrom and thereby prevent blockage of the apertures 16.

The user may selectively determine the substance flowing through the first and second apertures 14, 16 by depressing one of the plurality of buttons 20, 22, 24. The buttons 20, 22, 24 may be located on the outer surface of the showerhead 12. Operation of the dual hose showerhead system 10 was described hereinabove with specific reference to FIG. 4.

A showerhead holder 62 may be integrally attached to a side of the container 66 for retaining the showerhead 12 while not in use. Alternatively, the holder 62 may be secured to the downward leg 63 of the L-shaped pipe 60 with the container 66 being so dimensioned so that the showerhead 12 may be easily releasably attached to the holder 62 to the pipe 60.

FIG. 6 is a cross sectional view of the dual hose showerhead system 10. The dual hose showerhead system 10 may include the showerhead 12 attached to the hose sheath 26. The first conduit 28 and the second conduit 30 may be positioned within and extend through the hose sheath 26. The hose sheath 26 may prevent the conduits 28, 30 from getting tangled with one another. The first and second conduits 28, 30 may be connected to the corresponding first and second channels 84, 86 within the showerhead 12 via the first valve 64 and pass water therethrough, as described hereinabove with specific reference to FIG. 4.

Shown herein the faceplate 18 may cover the showerhead 12. Herein, a sponge attachment 68 may cover the faceplate 18. The faceplate 18 may include the plurality of first apertures 14 and the plurality of second apertures 16. Herein, each of the second apertures 16 may have larger openings and may be fewer in number than the first apertures 14. Clean water may be able to flow through both the first apertures 14 and the second apertures 16 at selected times, and thereby through the sponge attachment 68 as well. Soapy water may flow through the second apertures 16. The second apertures 16 may have larger openings than the first apertures 14 thereby allowing the soap residue to be expelled entirely therefrom and for preventing blockages of the apertures 16.

The sponge attachment 68 may enable a user to wash and exfoliate with the sponge while clean water, soapy water, or a mix thereof flows therethrough.

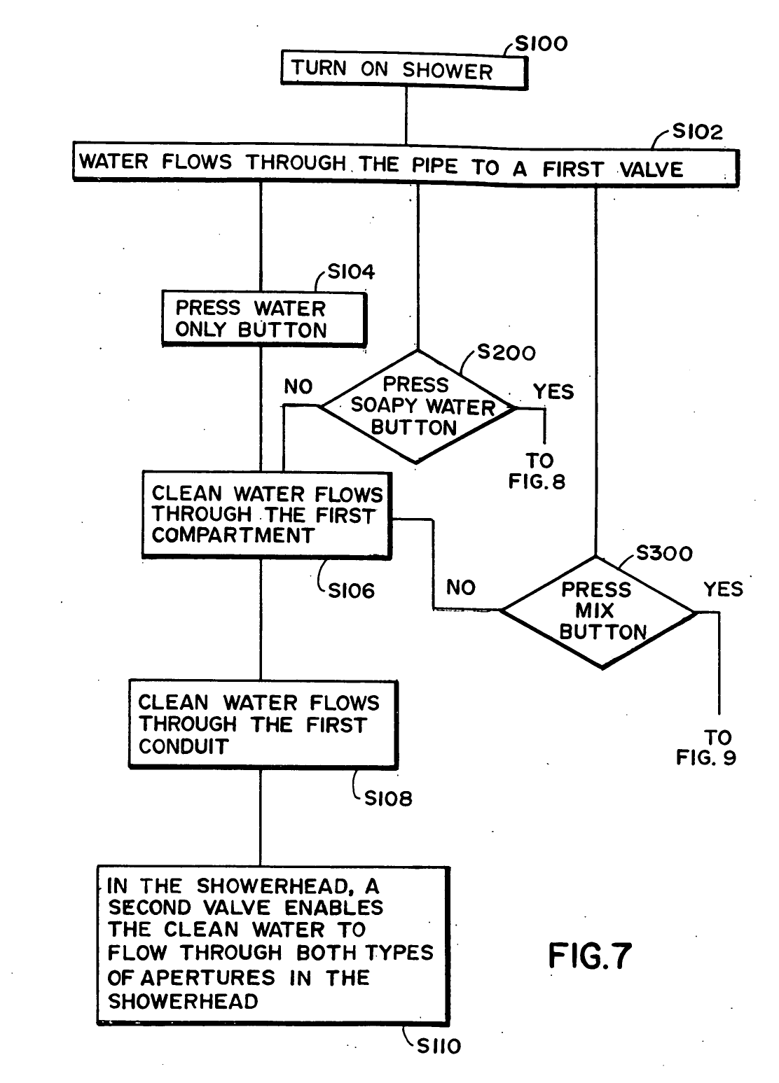

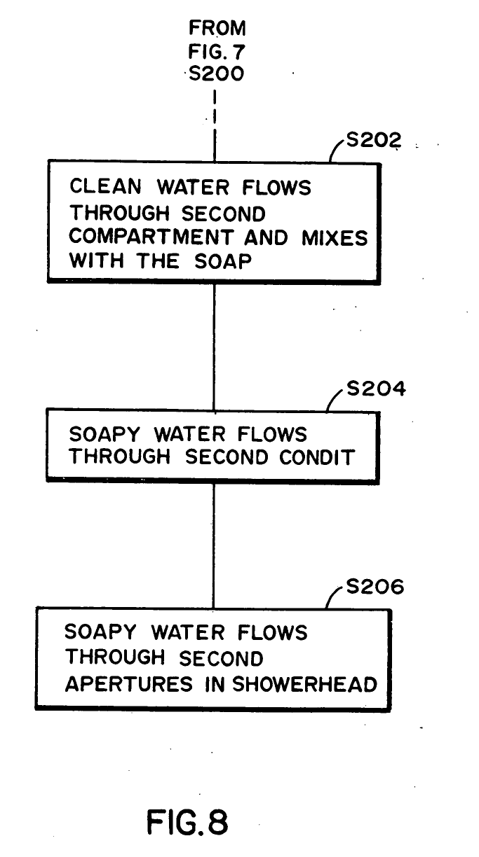

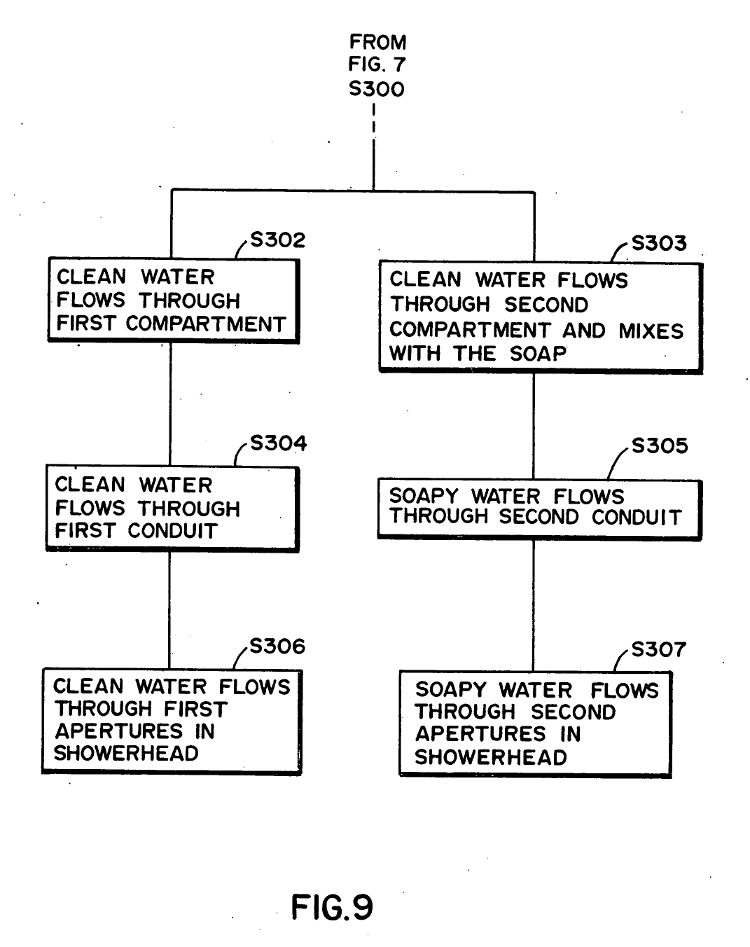

FIG. 7 is a flow diagram describing the operation of the dual hose showerhead system 10. In step S100, a user may turn on the shower. In step S102, clean water may flow through the pipe 60 to a first valve. In step S104, the user may press the water only button 20. Pressing the water only button 20 may cause the clean water to flow from the pipe 60 and into the first compartment 44 via the second valve 82 as described in step S106. From the first compartment 44, the clean water may flow through the first conduit 28 as stated in step S108. As described in step S110, a first valve 64 in the showerhead 12 may enable the clean water to flow from the first conduit 28 through both the first apertures 14 and the second apertures 16 located in the faceplate 18 of the showerhead 12.

Alternatively, after the water may flow through the pipe 60 to the first valve in step S102, if the soapy water button 22 is not pressed as stated in step S300, the dual hose showerhead system 10 may default to step S106, as described above, and follows the same steps thereafter. If the soapy water button 22 is pressed in step S200, the steps continue as described hereinafter with specific reference to FIG. 8.

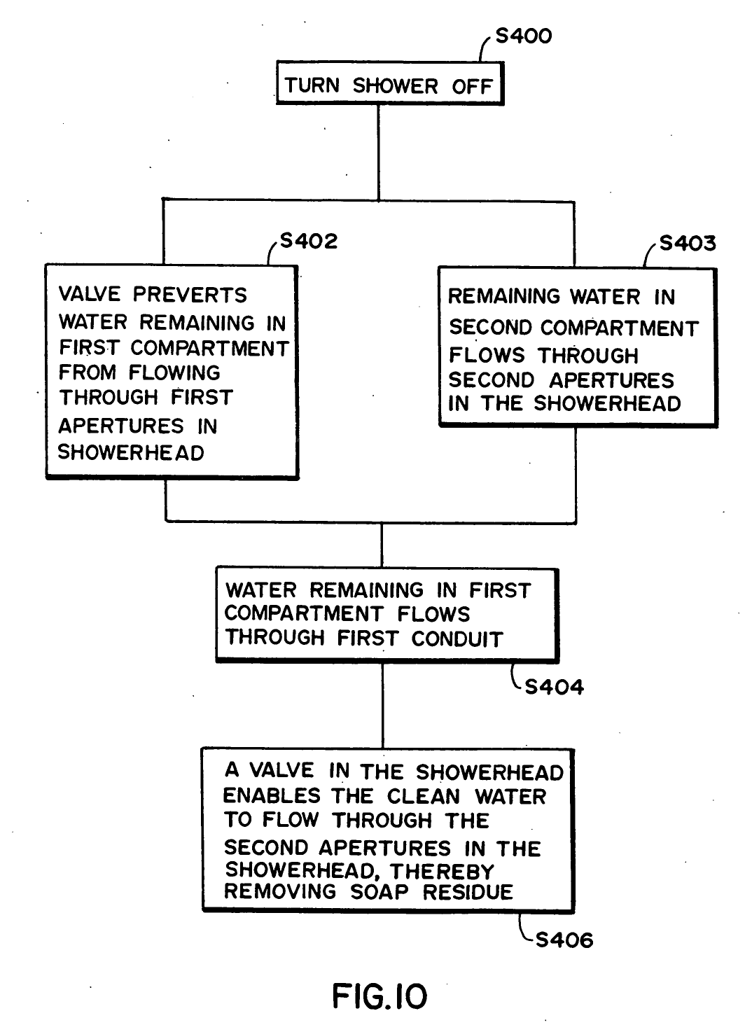

Alternatively, after the water may flow through the pipe 60 to the first valve in step S102, if the mix button 24 is not pressed in step S300, the dual hose showerhead system 10 may default to step S106, as described above, and follows the same steps thereafter. If the mix button 24 is pressed in step S300, the steps may continue as described hereinafter with specific reference to FIG. 9.

FIG. 8 is a flow diagram of the dual hose showerhead system 10 describing the steps following step S200 in FIG. 7. After the soapy water button 24 is pressed in S200, clean water may flow from the pipe 60 and into the second compartment 46 where it mixes with the soap therein as discussed in step S202. As stated in step S204, the soapy water solution may flow from the second compartment 46 into the second conduit 30. In step S206, the soapy water may then flow from the second conduit 30, into the showerhead 12 and be expelled through the second apertures 16 located within the faceplate 18 of the showerhead 12.

FIG. 9 is a flow chart describing the steps involved in the operation of the dual hose showerhead 10 following step S300 in FIG. 7. After pressing the mix button as described in step S300, clean water may flow from the pipe 60 and into the first compartment 44 as discussed in step S302. From the first compartment 44, the clean water may flow through the first conduit 28 as described in step S304. As stated in step S306, the clean water may flow from the first conduit 28 through the showerhead 12 and out of the first apertures 14 in the faceplate 18 of the showerhead 12. Steps S302, S304 and S306 occur simultaneously with steps S303, S305, and S307. As discussed in step S303, clean water may flow into the second compartment 46 and mix with the soap therein. The soapy water solution may flow from the second compartment 46 and into the second conduit 30 as stated in step S305. As described in step S307, the soapy water may flow from the second conduit 30, into the showerhead 12 and be expelled through the second apertures 16 located within the faceplate 18 of the showerhead 12.

FIG. 10 is a flow diagram describing the process of turning off the dual hose showerhead system 10. As discussed in step S400, the shower may be turned off. In step S402, a third valve may prevent the water remaining in the first compartment 44 from exiting the first compartment. As stated in step S403, which occurs simultaneously with step S402, the remaining water in the second compartment 46 may flow through the second conduit 30 and exit the dual hose showerhead system 10 through the second apertures 16 located within the faceplate 18 of the showerhead 12. As described in step S404, water remaining in the first compartment 44 may flow through the first conduit 28. The valve in the showerhead 12 may enable the clean water to flow from the first conduit 28 through the second apertures 16 in the faceplate 18, thereby removing the soapy residue that could build-up in the second apertures 16.

The dual hose showerhead system 10 may allow users to shower with shampoo and rinse off by the push of a few buttons, rather than fumbling with a plurality of bottles. Alternatively, at least one of the compartments can be filled with a body wash, instead of a shampoo. This is especially useful in terms of the elderly, people bathing small children and people bathing pets.

It will be understood that each of the elements described above, or two or more together may also find a useful application in other types of devices differing from the type described above.

While certain novel features have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

1. An apparatus of the type for dispensing water, a liquid soap, or combination thereof, comprising:
a receiving section including a first conduit and a second conduit;
a dispensing section including a faceplate, said faceplate having first and second sets of apertures; the openings of substantially all of said apertures of said first plurality of aperture being smaller than the openings of each of said apertures of said second plurality of apertures; said first conduit being connected to provide a flow of water for dispensing through said first plurality of apertures and said second conduit being connected to provide one of water or soap and water solution for dispensing through said second plurality of apertures.

2. The apparatus as recited in claim 1 further comprising:
a receptacle; and
a sheath, the sheath having a first end being connected to the receptacle and
a second end being connected to the receiving section.

3. The apparatus as recited in claim 2 a first channel and a second channel, said first and second channels each extending between said first and second ends.

4. The apparatus as recited in claim 3 wherein said receptacle includes a first compartment connectable to a supply of water and a second compartment connectable to a supply of water and capable of receiving therein the soap.

5. The apparatus as recited in claim 4 wherein said second compartment being capable of receiving water to be mixed with the soap; said first channel is so connected as to receive water from said first compartment and said second channel is connected so as to receive the water and soap solution from the second compartment.

6. The apparatus as recited in claim 5 further comprising a first valve for selectively connecting said first channel to said first conduit and said second channel to said second conduit.

7. The apparatus as recited in claim 6 wherein said first valve is moveable between a first position connecting said first channel to said first and second conduits, a second position connecting said second channel to said second conduit and a third position connecting said first channel to said first conduit and said second channel to said second conduit.

8. The apparatus as recited in claim 7 further comprising:
a first flow selector for placing said first valve in said first position;
a second flow selector for placing said first valve in said second position; and
a third flow selector for placing said first valve in said third position.

9. The apparatus as recited in claim 8 further comprising:
a control housing connected to said first, second, and third flow selectors for controlling said first valve.

10. The apparatus as recited in claim 8 wherein:
when said first valve is in said first position water is able to flow through said first and second conduits;
when said first valve is in said second position the soap and water solution is able to flow through said second conduit; and
when said first valve is in said third position water is able to flow through said first conduit and the soap and water solution is able to flow through said second conduit.

11. The apparatus as recited in claim 5 wherein said receptacle further comprises an ingress port in said second compartment for receiving the soap for use in forming the soap and water solution.

12. The apparatus as recited in claim 10 wherein said receptacle further comprises a second valve for attaching said receptacle to said water source and directing said flow of water into at least one of said first compartment and said second compartment.

13. The apparatus as recited in claim 1 wherein said first plurality of apertures is positioned on said faceplate above said second plurality of apertures.

14. The apparatus as recited in claim 1 wherein said first conduit has a larger diameter than said second conduit.

15. The apparatus as recited in claim 13 wherein said second apertures have a helical shape with the larger diameter of said helix being at the exit port.

16. The apparatus as recited in claim 8 wherein said control hosing comprises said faceplate, said flow selectors comprise buttons, with one of said buttons turning on an off the flow of soapy water; one of said buttons turning on and of the flow of water; one of said buttons substantially simultaneously turning on and off the flow of the clear water and soapy water.

17. The apparatus as recited in claim 16 wherein said buttons are of different shapes.

18. The apparatus as recited in claim 17 wherein said button for turning on and off the flow of soapy water is diamond shaped; said buttons for turning on and off the flow of water and substantially simultaneously turn of the flow of clear and soapy water are rectangular and further removed from said faceplate than said button for turning on and off the soapy water.

19. A method for dispensing at least one fluid comprising the activities of:
connecting a receptacle to a source of water for receiving water in first and second compartments thereof;
pouring a soap solution into the second compartment;
selectively allowing water to flow from the first compartment for dispensing through a first and second plurality of apertures in a showerhead in a first mode;
selectively allowing a soap and water solution to flow from the second compartment for dispensing through the second plurality of apertures in the showerhead while constricting a flow of water from dispensing through the first and second plurality of apertures in a second mode; and
selectively allowing water to flow from the first compartment for dispensing through the first plurality of apertures in the showerhead and a soap and water solution flowing from the second compartment for dispensing through the second plurality of apertures in the showerhead in a third mode.

20. A method as recited in claim 19 wherein the activity of selectively allowing water to flow from the first compartment through a first and second plurality of apertures in a showerhead includes the activities of:
selecting a first position flow selector; and
pivoting the first valve to cover a second channel and allow water to flow through first and second conduits for dispensing through the first and second plurality of apertures in the showerhead.

21. A method as recited in claim 19 wherein the activity of selectively allowing a soap and water solution to flow from the second compartment includes the activities of:
selecting a second flow selector;
pivoting the first valve allowing the soap and water solution to flow through a second conduit for dispensing through the second plurality of apertures in the showerhead.

22. A method as recited in claim 19 wherein the activity of selectively allowing water to flow from the first compartment for dispensing through the first plurality of apertures in the showerhead and a soap and water solution flowing from the second compartment for dispensing through the second plurality of apertures in the showerhead includes the activities of:
selecting a third flow selector;
pivoting the first valve allowing water to flow through a first conduit for dispensing through the first plurality of apertures in the showerhead and for allowing a soap and water solution to flow through a second conduit for dispensing through the second plurality of apertures in the showerhead.
